(19) United States
(12) Patent Application Publication
(10) Pub. No.: US 2019/0236636 A1
(43) Pub. Date: Aug. 1, 2019

(54) TARGETED CONTENT AND REWARDS

(71) Applicant: John E. De Titta, Fairport, NY (US)

(72) Inventor: John E. De Titta, Fairport, NY (US)

(21) Appl. No.: 16/258,179

(22) Filed: Jan. 25, 2019

Related U.S. Application Data
(60) Provisional application No. 62/623,167, filed on Jan. 29, 2018.

(51) Int. Cl. G06Q 30/02; H04N 21/258

(52) U.S. Cl. CPC G06Q 30/0224; H04N 21/25891; G06Q 30/0255

(57) ABSTRACT

A computer-implemented method, a computer program product, and a computer system include a processor(s) providing to a first computing node, a connection point to digital content from a content provider. The processor(s) determines that a processing device of the first computing node transmitted a threshold amount of the content to an interface of the first computing node. The processor(s) obtains, from the first computing node, identifying data. The processor(s) generates an incentive, based on the data, and transmits the incentive to the first computing node. The processor(s) utilizes a reward provided by the incentive when a second computing node connects to a computing resource. The processor(s) monitors usage of the reward by the second computing node and generates usage information related to the use of the reward by one or more of the second computing node and the first computing node, transmitting it to the content provider.

### BACKGROUND OF INVENTION

Online content, including news items as well as advertisements, is targeted toward various users using a variety of approaches, as it is in the best interest of content providers to provide users with relevant content. One method of determining what content is relevant to a given user is to tag a user of a website with a cookie, which is a small piece of data sent from a website and stored on the user's computer by the user's web browser while the user is browsing. Cookies were designed to be a reliable mechanism for websites to remember stateful information (such as items added in the shopping cart in an online store) or to record the user's browsing activity (including clicking particular buttons, logging in, or recording which pages were visited in the past). They can also be used to remember arbitrary pieces of information that the user previously entered into form fields such as names, addresses, passwords, and credit card numbers.

### SUMMARY OF INVENTION

Shortcomings of the prior art are also overcome and additional advantages are provided through the provision of a method for targeting content to users for relevant rewards, the method includes: providing, by the one or more processors of a distributed computing system, to a first computing node, a connection point to digital content from a content provider; determining, by the one or more processors, that a processing device of the first computing node has transmitted a pre-determined threshold amount of the content to an interface of the first computing node; obtaining, by the one or more processors, from the first computing node, data identifying one or more of the first computing node or the user of the first computing node; generating or selecting, by the one or more processors, an incentive, based on the data; transmitting, by the one or more processors, the incentive to the first computing node; obtaining, by the one or more processors, the incentive from a second computing node; responsive to obtaining the incentive providing, by the one or more processors, a reward, the reward comprising a unique identifier, wherein utilization of the reward comprises the second computing node connecting to a computing resource in the distributed computing system; monitoring, by the one or more processors, usage of the reward by the second computing node; based on the monitoring, generating, by the one or more processors, usage information related to the use of the reward by one or more of the second computing node and the first computing node; and transmitting, by the one or more processors, the usage information to the content provider.

Computer systems, computer program products, and methods relating to one or more aspects of the technique are also described and may be claimed herein. Further, services relating to one or more aspects of the technique are also described and may be claimed herein.

Additional features are realized through the techniques of the present invention. Other embodiments and aspects of the invention are described in detail herein and are considered a part of the claimed invention.

### BRIEF DESCRIPTION OF DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawings.

FIG. 1 depicts a technical environment into which aspects of embodiments of the present invention may be implemented.

FIG. 2 illustrates a workflow of certain embodiments of the present invention.

FIG. 3 depicts one embodiment of a single processor computing environment, which may comprise a node of a cloud computing environment, to incorporate and use one or more aspects of the present invention.

FIG. 4 depicts one embodiment of a computer program product incorporating one or more aspects of the present invention.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. The terms software, program code, and one or more programs are used interchangeably throughout this application. In some embodiments of the present invention, one or more programs may also refer to hardware processes.

Embodiments of the present invention include a computer-implemented method, a computer program product, and a computer system that includes one or more programs that incentivize the utilization of content, including but not limited to, electronic media files, and provide, through the electronic incentives, a manner in which to continue to track the users to provide timely targeted content. In some embodiments of the present invention, one or more programs: 1) obtain data from a user (individual or application) based on the user's interaction with content; 2) provide the user with a temporal incentive based on the user's interaction with the content; and 3) provide the user with a manner in which to redeem the temporal incentive; 4) based on the redemption of the incentive and/or the failure of the user to redeem the incentive, obtain additional information relevant to targeting the user with additional content; and 5) target the user with additional content, which is targeted based on the ongoing activities of the user and interactions with the previously supplied content, as well as with future content.

Embodiments of the present invention are inextricably tied to computing and offer significantly more than existing approaches to electronic user incentivizing and monitoring. First, embodiments of the present invention are inextricably tied to computing at least because the embodiments include one or more programs executing on at least one processor that target and incentivize users (with digital content and incentives) based on utilizing computing devices, including mobile devices and Internet of Things devices, to track user activity, user location, and obtain historical usage data. As will be described herein, the targeted incentives generated and/or provided by one or more programs in embodiments of the present invention are temporal and thus, the continued connectivity and interconnectivity of the various distributed computing systems utilized in embodiments of the present invention manage the incentives, including upgrading and/or expiring the earned incentives, at various times. Some embodiments of the present invention rely upon the connectivity and accessibility of various computing devices with applications that include identifying data, content, incentives, and additional data utilized to target the content. This inter-connectivity is central to the temporal aspects of embodiments of the present invention. By providing the incentives for interacting with targeted electronic content, one or more programs in embodiments of the present invention, provide a more efficient way of interacting with content users and continuously providing the users with targeted electronic content, through the utilization of relevant incentives. From an ecommerce perspective, the novel incentive process enables electronic marketplaces quickly to identify and maintain relationships with consumers. Some embodiments of the present invention provide advantages over existing targeted content systems because in these embodiments, the one or more programs are able not only to determine that a user is responsive to a type of content, the one or more programs may also determine a level of interest in the content (e.g., a user who redeems an incentive more quickly and collects more incentives based on interacting with a specific type of content may have a higher level of interest). Additionally, based on tracking subsequent actions of the user, including but not limited to the redemption of the incentive, the one or more programs can continue to monitor the user and to analyze the user in order to generate additional information to be used for more comprehensive targeting. In some embodiments of the present invention, the one or more programs may utilize machine learning to continuously learn and update information related to the user (and the behavior of the user in interacting with the content and utilizing the incentives) to determine how to continue to target the user in a manner that results both in the user interacting with increasing amounts of targeted content and taking advantage of the incentives awarded based on these interactions. Thus, embodiments of the present invention provide advantages of existing targeted content systems because these embodiments enables a user to “opt-in” to receiving targeted content in a definitive manner thus enabling one or more programs to continuously track user activity, in a manner that eliminates false positive regarding interest in content, throughout interaction with content and subsequent actions based on this interaction. Additionally, embodiments of the present invention represent a practical application to a technical challenge in computing.

Second, various embodiments of the present invention provide significantly more than existing approaches to providing targeted content to users. As explained below, embodiments of the present invention incentivize the utilization of electronic content and through this utilization and the tracking of this utilization, track users in order to provide timely content to users.

As discussed above, the efficacy of various embodiments of the present invention is based, in part, on the prevalence of personalized computing devices, such as Internet of Things (IoT) devices. The Internet of Things (IoT) is a system of interrelated computing devices, mechanical and digital machines, objects, animals and/or people that are provided with unique identifiers and the ability to transfer data over a network, without requiring human-to-human or human-to-computer interaction. These communications are enabled by smart sensors, which include, but are not limited to, both active and passive radio-frequency identification (RFID) tags, which utilize electromagnetic fields to identify automatically and to track tags attached to objects and/or associated with objects and people. Smart sensors, such as RFID tags, can track environmental factors related to an object, including but not limited to, temperature and humidity. The smart sensors can be utilized to measure temperature, humidity, vibrations, motion, light, pressure and/or altitude. IoT devices also include individual activity and fitness trackers, which include (wearable) devices or applications that include smart sensors for monitoring and tracking fitness-related metrics such as distance walked or run, calorie consumption, and in some cases heartbeat and quality of sleep and include smartwatches that are synced to a computer or smartphone for long-term data tracking. Because the smart sensors in IoT devices carry unique identifiers, a computing system that communicates with a given sensor can identify the source of the information. Within the IoT, various devices can communicate with each other and can access data from sources available over various communication networks, including the Internet.

In some embodiments of the present invention, the targeted content and/or the incentives are provided to and/or experienced by, the user utilizing less conventional computing devices, including but not limited to, IoT devices. Based on utilizing IoT devices, the one or more programs can provide a high quality of targeted content and monitor the reward and the redemption of incentives by the user on a continuous basis. Additionally, the utilization of non-conventional devices by the users enables the one or more programs to generate content and incentives that are particular to the IoT device of the user and the activities of the user that are tracked utilizing the IoT device.

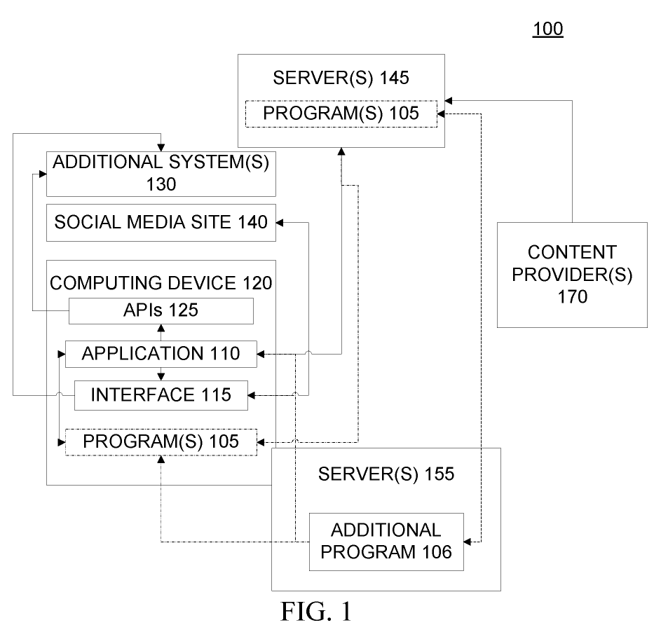

FIG. 1 is a diagram of a technical environment 100 into which one or more aspects of some embodiments of the present invention may be integrated. In an embodiment of the present invention, one or more programs 105 provide content to an application 110 that is viewed or otherwise experienced through an interface 115 (e.g., graphical user interface (GUI), audio interface, etc.) of a computing device 120 (e.g., computing node, mobile device, IoT device). In some embodiments of the present invention, this content may be available contemporaneously with other content. For example, if the content is a media file and the interface 115 is a GUI, the media file may appear in the GUI together with the expected application content that is accessible to the user through the GUI.

The one or more programs 105 in embodiments of the present invention may be executed locally by the computing device 120 or may be executed, in part on one or more processors of one or more servers 145 of a distributed computing system. The distributed computing system may comprise a cloud computing environment. The one or more servers 145 provide content (e.g., as a service) but may not provide the application content, that user views contemporaneously with the content from the one or more servers 145. The one or more programs 105 may provide the content to the interface 115 responsive to a call from the interface 115 and/or responsive to a call from an application responsible for the application content. In this technical environment 100, the additional application 106 providing the application content is executed at least in part by one or more other servers 155. For example, in order to provide content from the one or more servers 145, a developer may implement certain program code in the additional application 106 executed by the other one or more servers 155. Thus, at runtime, or when a computing device 120 (e.g., program code executing on the computing device) accesses the additional application 106, the additional application 106 calls the one or more programs 105 to provide the content. In another embodiment of the present invention, the interface 115 requests content (e.g., automatically) when a user utilizes the interface 115 to view the additional application 106 content.

In some embodiments of the present invention, the one or more programs 105 obtain data, including activity-related, identifying data, or personal data. The computing device 120 may be storing attributes related to the user, including cookies, identification information (e.g., personal identification information, a unique identifier), for example, on a memory internal to the computing device or accessible to the computing device 120 over a network connection, including but not limited to, a wireless connection. Certain of this user data may be available from the application and the user's interaction with the application 110 (e.g., a user profile, user credentials). Based on the user's interaction with the content and/or the one or more programs 105 providing the content on the computing device 120 through the interface 115, the one or more programs 105 may gain access to additional systems 130 in communication with the computing device 120, for example, by utilizing application programming interfaces (APIs) 125 executed by the computing device 120. For example, the computing device 120 may provide an access point to a social media site 140 where additional user information is available. If the computing device 120 is an IoT device that is logged into a social media site, the one or more programs 105 in an embodiment of the present invention may utilize this pre-existing connection to gather data regarding the user, including preferences, attributes, usage statistics, usernames, and additional profile data. In some embodiments of the present invention, the one or more programs 105 may obtain data from the social media site that indicates various businesses that the user frequents. The one or more programs 105 may also obtain location data from the computing device 120, including from any systems within the computing device that utilize location services, including but not limited to, GPS and/or triangulation based on cellular networks.

In some embodiments of the present invention, the one or more programs 105 determine that a user has met a threshold for interaction with the content via the interface 115 of the computing device 120. For example, if the interface includes a media player and the content is a video, the one or more programs 105 may determine that the user has viewed the entirety of the video file. In another embodiment of the present invention, the one or more programs 105 provide an audio file as content and the one or more programs 105 determine if the interface 125 has played the entirety of the file. In another embodiment of the present invention, the content is a quiz that solicits entries from a user through an input/output device. The one or more programs 105 provide the quiz to the interface 115 and the threshold may be met when the user completes the quiz. Thus, the one or more programs 105 provide the computing device 120 with the content and may determine that the threshold has been reached by determining that a processing device of the computing device 120 has transmitted a threshold amount of the content, for example, to the interface 115, which provides the content to the user.

Based on the user meeting the threshold for interaction with the content via the interface 115 (e.g., via a processing resource in the computing device transmitting a threshold amount of the content to the interface 115), the one or more programs 105 provide the user with an (electronic) incentive. The incentive may be one or more files representing digital currency and/or digital credits. The digital currency may comprise an electronic certificate that enables the user to connect to a restricted system, for example, a user may utilize the electronic certificate to access secure content on additional systems 130. When executed by a processor of the computing device 120, the incentive, which comprises one or more program files, may automatically connect the user to an application, including but not limited to, an online content service (e.g., an additional system 130). In some embodiments of the present invention, the incentives provided comprise electronic currency that the user can utilize to select a reward. To award the incentive to the user, the one or more programs 105 may provide the computing device with the incentive (e.g., a marker, a cookie, alter an available bit in a memory, and/or provide a file that the computing device can save to a memory, and/or automatically save a file to a memory accessible to the computing device 120). In an embodiment of the present invention, the incentive includes a unique identifier, such that when or if it is utilized by the computing device 120 with which it was associated to redeem a reward, the one or more programs 105 can recognize the redeemer of the incentive. In some embodiments of the present invention, the incentive includes an expiry date, for example, a timestamp. Should the user attempt to utilize the incentive to redeem the reward after the expiry date has lapsed, the one or more programs 105 of an embodiment of the present invention will not provide the reward.

In an embodiment of the present invention, the one or more programs 105 obtain the incentive (previously provided to the computing device 120 by the one or more programs 105) and determine whether to provide a reward. In some embodiments of the present invention, the reward may be access to an enhanced communication service and/or additional content. In some embodiments of the present invention, the one or more programs 105 may accept the incentive as electronic currency and enable the user to select an item, provided through the interface 115, based on determining that the incentive is equivalent to the value of the reward. In some embodiments of the present invention, in order to redeem the incentive through the interface 115, the interface is connected to a new application, which may be in a different domain and/or executed in part on a different server than the application 110.

To redeem the incentive, in an embodiment of the present invention, a user may utilize functionality in the interface 115 in order to navigate to a website and/or launch a new application. As aforementioned, the incentive may automatically launch the application or navigate a web browser to a website, once selected by the user, or as part of being provided by the one or more programs 105. From the application and/or website, the one or more programs 105 obtain, from the user, the incentive. The one or more programs 105 analyze the incentive to determine what reward the user should be awarded.

The available rewards may be saved in a memory accessible to the one or more programs 105 and may have been provided, electronically, by the sources of the incentives. The incentive may include a value and the one or more programs 105 may select a reward that is commensurate with the value of the incentive. In some embodiments of the present invention, the incentive may include attributes and the one or more programs 105 may select a reward based on the attributes. In some embodiments of the present invention, based on (or contemporaneously with) obtaining the incentive, the one or more programs 105 may access information about the user, for example, from a profile of the user that the user accesses with the computing device 120. The one or more programs 105 may select the reward for the incentive based on data associated with the user profile. In some embodiments of the present invention, the one or more programs 105 may obtain usage statistics of the computing device 120 in order to determine preferences of the user. The one or more programs 105 may determine the reward based on these preferences. The one or more programs 105 may also solicit, through the interface 115, a selection of a reward by the user, based on obtaining the incentive. As aforementioned, before providing the reward, the one or more programs 105 may determine if the incentive is valid or has expired. The one or more programs 105 will transmit the reward to the user only if the incentive is valid. In some embodiments of the present invention, the reward includes unique identifying information so that the one or more programs 105 can continue to collect data about the user (to provide targeted content to the user).

In various embodiments of the present invention, user-specific information, including but not limited to user identifying information, browsing history, usage history, profile data, profile-linked attributes, etc., may be utilized by the one or more programs 105 to: 1) provide the content, which the user experiences to earn the incentive; 2) determine the incentive to the user who experiences the content; and 3) determine an award to provide in exchange for the incentive. The one or more programs also obtain data based on supplying content to a computing device 120 and the user failing to complete a threshold portion of the content (including failing to launch/select the content). In the event that a user does not meet this threshold, the one or more programs may still obtain data from the computing device 120 and provide this data to the content providers. The one or more programs may also send a notification to the content provider if a given number (a pre-defined threshold and/or percent) of users are not engaging with a specific content offering. Based on receiving this notification, the one or more programs may receive new content from the content provider to utilize in place of the content that is not engaging the users.

The one or more programs 105 may continue to track the user (and/or the computing device 120) activity after the user redeems the reward. In some embodiments of the present invention, the reward comprises authorization to connect to a service (available online), through the computing device 120 or another computing device, by the user (e.g., for a given period of time). In this example, the one or more programs 105 track the activity of the user utilizing the reward. The one or more program utilize this data to provide further content, which can lead the user to obtain additional incentives, and based on the incentives, receive rewards. The one or more programs 105 may employ a machine learning algorithm to track the activity of the user (as well as any personal data available) from the moment that the user meets the threshold related to the initial content through the user's usage of a reward.

In some embodiments of the present invention, the one or more programs 105 provide the user data it collects and analyzes throughout the process to applications that provide the content. The applications may utilize this data to modify the content they provide to target various users more appropriately. For example, a content provider 170 may transmit, to the one or more programs 105, a video file related to a sport that includes the use of a sports team to sell a product. The one or more programs 105 determine that this content is observed primarily by individuals in a given geographic area and a smaller than expected percentage of the users who receive incentives for watching the content, redeem the incentives. The content provider 170 may determine, based on this data, that the sports team featured in the content is a rival team to the home team of the location of the users. Based on this data, the content provider 170 may modify the content to feature the home team of the location of the users, in an effort to increase the percentage of users who redeem the incentives. It is in the interest of the content providers 170 to increase this percentage because the users who redeem the incentives may be tracked through the use of the rewards. The one or more programs 105 can then continue to provide updated user data (both individual and aggregated based on content) to the content providers 170.

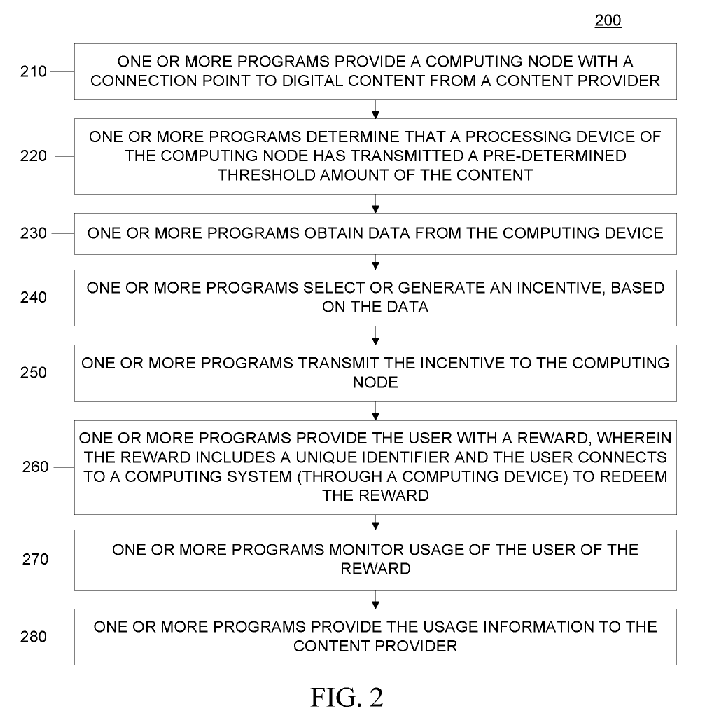

FIG. 2 is a workflow 200 of various aspects of some embodiments of the present invention. In some embodiments of the present invention, one or more programs provide a computing node with a connection point to digital content from a content provider (210). The connection point could be a “play button” in the interface, or an audio queue that prompts the user to make a selection on an input/output (I/O) device coupled to or internal to the computing node to connect, including, but not limited to, a touchscreen. In some embodiments of the present invention, the user may interact with the computing device using voice recognition and/or haptic cues.

The one or more programs determine that a processing device of the computing node has transmitted a pre-determined threshold amount of the content (220). For example, if the content is an audio or video file, the computing node receives this file, one or more processors of the computing node decode the file, and continuously transmit the decoded data (e.g., as it is decoded) to an interface of the computing node, which renders the content in a manner that can be experienced (seen, heard) by the user. If the content is a survey, the processor(s) does not decode the content, unless it is encoded, before transmitting it to the interface.

Based on determining that the computing node has transmitted a pre-determined threshold amount of the content, the one or more programs obtain data from the computing device (230). Some types of data that the one or more programs may obtain are discussed above, however, the data may enable the one or more programs to identify the computing node and/or identify attributes related to the user. The one or more programs select or generate an incentive, based on the data (240). The one or more programs transmit the incentive to the computing node (250). As discussed above, the user may utilize the same computing node to redeem the incentive or may utilize a different computing device. However, in some embodiments of the present invention, the incentive includes a unique identifier, so the one or more programs can identify the computing node the user utilized to “earn” the incentive and, potentially, the user (or data related to the user that was obtained and retained). If the computing device used to redeem the incentive is different than the initial computing device, the one or more programs can retain the association of a user with both devices and monitor future activity involving both devices for use in providing additional targeted content, incentives, and/or rewards, to the user.

Based on obtaining the incentive, the one or more programs provide the user with a reward, wherein the reward includes a unique identifier and the user connects to a computing system (through a computing device) to redeem the reward (260). The one or more programs monitor usage of the user of the reward (270). The one or more programs provide the usage information to the content provider (280).

In some embodiments of the present invention, the incentive indicates the reward to the user, so that the user can immediately receive the award. For example, the incentive may indicate to the user that the user may access a subscription-only service, providing, for example, a code for a time-restricted subscription. The user may utilize the code to connect to the subscription service. Because the code is unique, the one or more programs can monitor the user's usage of the subscription service. The one or more programs may pass the data about the user and/or the computing device of the user to the content provider and the content provider may track the user's utilization of the reward (e.g., subscription).

In some embodiments of the present invention, the reward may be use or time limited and may expire if the time and/or use conditions are met. When the user's access to the reward expires, the one or more programs may provide the user with content to enable the user to “earn” continued use of the reward by interacting with the content. In some embodiments of the present invention, the one or more programs monitor usage of the reward directly and send new content when the usage conditions have been met. In some embodiments of the present invention, the content provider alerts the one or more programs to the expiration of the reward and the one or more programs provide the user with content that will provide an incentive of continued use. In some embodiments of the present invention, the reward may comprise a digital certificate that identifies the user and includes an expiration. This information may be encrypted in a manner that can only be deciphered upon redemption.

Embodiments of the present invention include a computer-implemented method, a computer program product, and a computer systems where program code executing on one or more processors of a distributed computing system, provide to a first computing node, a connection point to digital content from a content provider. The program code determines that a processing device of the first computing node has transmitted a pre-determined threshold amount of the content to an interface of the first computing node. The program code obtains, from the first computing node, data identifying one or more of the first computing node or the user of the first computing node. The program code generates or selects an incentive, based on the data. The program code transmits the incentive to the first computing node. The program code obtains the incentive from a second computing node. Responsive to obtaining the incentive, the program code provides a reward, the reward comprising a unique identifier, where utilization of the reward comprises the second computing node connecting to a computing resource in the distributed computing system. The program code monitors usage of the reward by the second computing node. Based on the monitoring, the program code generates usage information related to the use of the reward by one or more of the second computing node and the first computing node. The program code transmits the usage information to the content provider.

In some embodiments of the present invention, the first computing node and the second computing node comprise a common computing node. In some embodiments of the present invention, the first computing node and the second computing node comprise different computing nodes.

In some embodiments of the present invention, responsive to the usage information, the program code obtains additional content from the content provider. The program code provides to the first computing node, a connection point to additional content from a content provider.

In some embodiments of the present invention, responsive to the usage information, the program code obtains additional content from the content provider. The program code provides to the second computing node, a connection point to additional content from a content provider.

In some embodiments of the present invention, the reward is encrypted and utilization of the reward further comprises the computing resource decrypting the reward upon connection of the second computing node to the computing resource.

In some embodiments of the present invention, the reward comprises digital currency comprising an electronic certificate that enables the second computing to connect to a restricted system executing on the computing resource.

In some embodiments of the present invention, the providing is automatic subsequent to the obtaining.

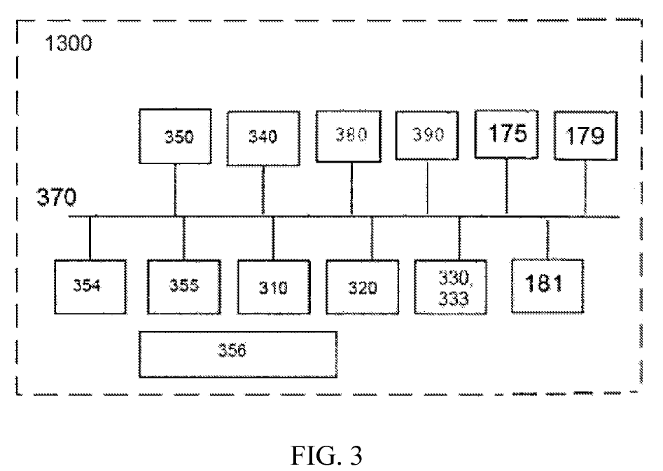

FIG. 3 illustrates a block diagram of a resource 1300, such as computing device 120, and other resources of computer system 100, which is part of the technical architecture of certain embodiments of the technique. The resource 1300 may include a circuitry 370 that may in certain embodiments include a microprocessor 354. The computer system 1300 may also include a memory 355 (e.g., a volatile memory device), and storage 181. The storage 181 may include a non-volatile memory device (e.g., EPROM, ROM, PROM, RAM, DRAM, SRAM, flash, firmware, programmable logic, etc.), magnetic disk drive, optical disk drive, tape drive, etc. The storage 355 may comprise an internal storage device, an attached storage device and/or a network accessible storage device. The system 1300 may include a program logic 330 including code 333 that may be loaded into the memory 355 and executed by the microprocessor 356 or circuitry 370.

In certain embodiments, the program logic 330 including code 333 may be stored in the storage 181, or memory 355. In certain other embodiments, the program logic 333 may be implemented in the circuitry 370. Therefore, while FIG. 3 shows the program logic 333 separately from the other elements, the program logic 333 may be implemented in the memory 355 and/or the circuitry 370.

Using the processing resources of a resource 1300 to execute software, computer-readable code or instructions, does not limit where this code can be stored.

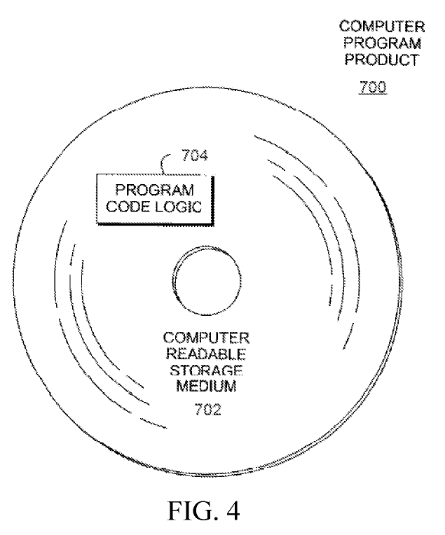

Referring to FIG. 4, in one example, a computer program product 700 includes, for instance, one or more non-transitory computer readable storage media 702 to store computer readable program code means or logic 704 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, Java, Python, R-Language, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions, also referred to as computer program code, may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique. As a further aspect of the technique, the system can operate in a peer to peer mode where certain system resources, including but not limited to, one or more databases, is/are shared, but the program code executable by one or more processors is loaded locally on each computer (workstation).

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

Embodiments of the present invention may be implemented in cloud computing systems. FIG. 3 may also comprise a node in this type of computing environment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the descriptions below, if any, are intended to include any structure, material, or act for performing the function in combination with other elements as specifically noted. The description of the technique has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, comprising:
providing, by one or more processors of a distributed computing system, to a first computing node, a connection point to digital content from a content provider;
determining, by the one or more processors, that a processing device of the first computing node has transmitted a pre-determined threshold amount of the content to an interface of the first computing node;
obtaining, by the one or more processors, from the first computing node, data identifying one or more of the first computing node or the user of the first computing node;
generating or selecting, by the one or more processors, an incentive, based on the data;
transmitting, by the one or more processors, the incentive to the first computing node;
obtaining, by the one or more processors, the incentive from a second computing node;
responsive to obtaining the incentive providing, by the one or more processors, a reward, the reward comprising a unique identifier, wherein utilization of the reward comprises the second computing node connecting to a computing resource in the distributed computing system;
monitoring, by the one or more processors, usage of the reward by the second computing node;
based on the monitoring, generating, by the one or more processors, usage information related to the use of the reward by one or more of the second computing node and the first computing node; and
transmitting, by the one or more processors, the usage information to the content provider.

2. The computer-implemented method of claim 1, wherein the first computing node and the second computing node comprise a common computing node.

3. The computer-implemented method of claim 1, wherein the first computing node and the second computing node comprise different computing nodes.

4. The computer-implemented method of claim 1, further comprising:
responsive to the usage information, obtaining, by the one or more processors, additional content from the content provider; and
providing, by one or more processors, to the first computing node, a connection point to additional content from a content provider.

5. The computer-implemented method of claim 1, further comprising:
responsive to the usage information, obtaining, by the one or more processors, additional content from the content provider; and
providing, by one or more processors, to the second computing node, a connection point to additional content from a content provider.

6. The computer-implemented method of claim 1, wherein the reward is encrypted and utilization of the reward further comprises the computing resource decrypting the reward upon connection of the second computing node to the computing resource.

7. The computer-implemented method of claim 1, wherein the reward comprises digital currency comprising an electronic certificate that enables the second computing to connect to a restricted system executing on the computing resource.

8. The computer-implemented method of claim 1, wherein the providing is automatic subsequent to the obtaining.

9. A computer program product comprising:
a computer readable storage medium readable by one or more processors in a distributed computing environment, and storing instructions for execution by the one or more processors for performing a method comprising:
providing, by one or more processors of a distributed computing system, to a first computing node, a connection point to digital content from a content provider;
determining, by the one or more processors, that a processing device of the first computing node has transmitted a pre-determined threshold amount of the content to an interface of the first computing node;
obtaining, by the one or more processors, from the first computing node, data identifying one or more of the first computing node or the user of the first computing node;
generating or selecting, by the one or more processors, an incentive, based on the data;
transmitting, by the one or more processors, the incentive to the first computing node;
obtaining, by the one or more processors, the incentive from a second computing node;
responsive to obtaining the incentive providing, by the one or more processors, a reward, the reward comprising a unique identifier, wherein utilization of the reward comprises the second computing node connecting to a computing resource in the distributed computing system;
monitoring, by the one or more processors, usage of the reward by the second computing node;
based on the monitoring, generating, by the one or more processors, usage information related to the use of the reward by one or more of the second computing node and the first computing node; and
transmitting, by the one or more processors, the usage information to the content provider.

10. The computer program product of claim 9, wherein the first computing node and the second computing node comprise a common computing node.

11. The computer program product of claim 9, wherein the first computing node and the second computing node comprise different computing nodes.

12. The computer program product of claim 9, further comprising:
responsive to the usage information, obtaining, by the one or more processors, additional content from the content provider; and
providing, by one or more processors, to the first computing node, a connection point to additional content from a content provider.

13. The computer program product of claim 9, further comprising:
responsive to the usage information, obtaining, by the one or more processors, additional content from the content provider; and
providing, by one or more processors, to the second computing node, a connection point to additional content from a content provider.

14. The computer program product of claim 9, wherein the reward is encrypted and utilization of the reward further comprises the computing resource decrypting the reward upon connection of the second computing node to the computing resource.

15. The computer program product of claim 9, wherein the reward comprises digital currency comprising an electronic certificate that enables the second computing to connect to a restricted system executing on the computing resource.

16. The computer program product of claim 9, wherein the providing is automatic subsequent to the obtaining.

17. A system comprising:
one or more memory;
one or more processors in communication with the memory; and
program instructions executable by the one or more processors in a distributed computed environment via the one or more memory to perform a method, the method comprising:
providing, by the one or more processors of a distributed computing system, to a first computing node, a connection point to digital content from a content provider;
determining, by the one or more processors, that a processing device of the first computing node has transmitted a pre-determined threshold amount of the content to an interface of the first computing node;
obtaining, by the one or more processors, from the first computing node, data identifying one or more of the first computing node or the user of the first computing node;
generating or selecting, by the one or more processors, an incentive, based on the data;
transmitting, by the one or more processors, the incentive to the first computing node;
obtaining, by the one or more processors, the incentive from a second computing node;
responsive to obtaining the incentive providing, by the one or more processors, a reward, the reward comprising a unique identifier, wherein utilization of the reward comprises the second computing node connecting to a computing resource in the distributed computing system;
monitoring, by the one or more processors, usage of the reward by the second computing node;
based on the monitoring, generating, by the one or more processors, usage information related to the use of the reward by one or more of the second computing node and the first computing node; and
transmitting, by the one or more processors, the usage information to the content provider.

18. The computer system of claim 17, wherein the first computing node and the second computing node comprise a common computing node.

19. The computer system of claim 17, wherein the first computing node and the second computing node comprise different computing nodes.

20. The computer system of claim 17, further comprising:
responsive to the usage information, obtaining, by the one or more processors, additional content from the content provider; and
providing, by one or more processors, to the first computing node, a connection point to additional content from a content provider.
